(19) United States
(12) Patent Application Publication
(10) Pub. No.: US 2025/0292264 A1
(43) Pub. Date: Sep. 18, 2025

(54) OPTIMIZING DATA TOLERANCE VALUE

(71) Applicant: DELL PRODUCTS L.P., Round Rock, TX (US)

(72) Inventors: Balasingh Samuel, Round Rock, TX (US); Farzad Khosrowpour, Pflugerville, TX (US)

(21) Appl. No.: 18/602,988

(22) Filed: Mar. 12, 2024

(51) Int. Cl. G06Q 30/018

(52) U.S. Cl. CPC G06Q 30/018

(57) ABSTRACT

An information handling system generates a data tolerance policy with a data tolerance value for a data type. If a data collection request meets a set of criteria that includes whether a number of active data collection policies exceeds a threshold, then the system modifies the data tolerance value of the data type in the data tolerance policy. The system instruments data according to a modified data tolerance value, the data collection request, and the data tolerance policy.

### FIELD OF THE DISCLOSURE

The present disclosure generally relates to information handling systems, and more particularly relates to optimizing data tolerance value.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system generates a data tolerance policy with a data tolerance value for a data type. If a data collection request meets a set of criteria that includes whether a number of active data collection policies exceeds a threshold, then the system modifies the data tolerance value of the data type in the data tolerance policy. The system instruments data according to a modified data tolerance value, the data collection request, and the data tolerance policy.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of a telemetry system according to an embodiment of the present disclosure;

FIG. 3 is a flowchart of a method for optimizing a data tolerance value, according to an embodiment of the present disclosure;

FIG. 4 is a table of a data tolerance policy according to at least one embodiment of the present disclosure;

FIGS. 5-7 are tables of data collection policies according to at least one embodiment of the present disclosure;

FIG. 8 is a table of a data optimization policy according to at least one embodiment of the present disclosure; and

FIG. 9 is a flowchart of a method for optimizing data tolerance values, according to at least one embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

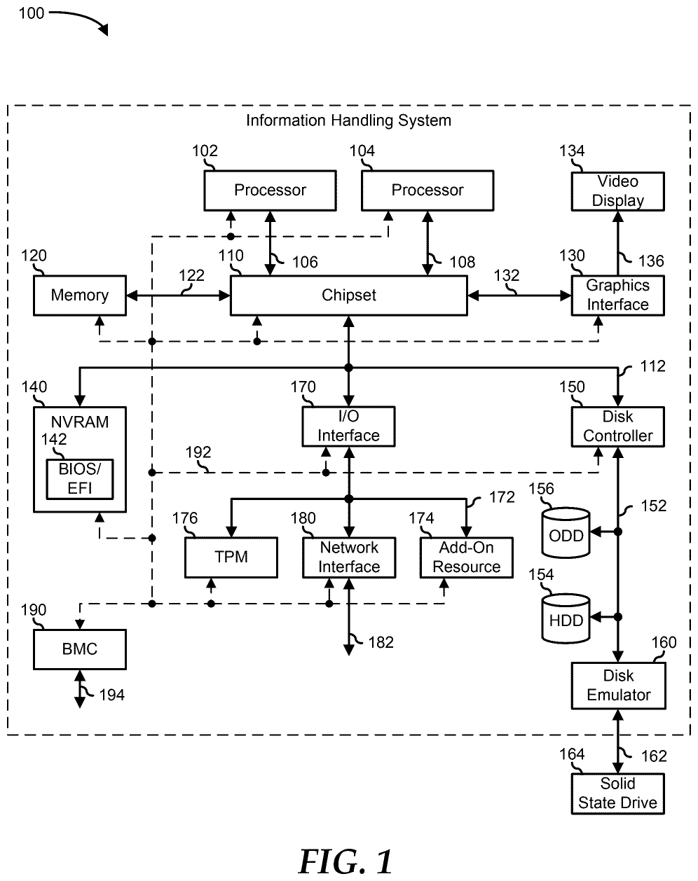

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Periodic data collection of a subsystem at a predefined/fixed or policy-based frequency can negatively impact system performance. For example instrumenting platform-level data requires CPU cycles, memory access, and I/O access. Often multiple applications, such as out-of-the-box and/or cloud-based microservices, request periodic data collection at the same time. In addition, the applications are typically transitioning to a data-driven approach. Collecting data from end-point devices therefore is likely to increase. If many applications are instrumenting data from a telemetry service, then its system may experience heavy load which can negatively impact its performance. Thus, there is a need to improve the current telemetry system and method by optimizing the data collection mechanism. This may be accomplished by reducing I/O access by modifying data tolerance values of one or more data types which can decrease the negative impact on the system's performance. Accordingly, the present disclosure provides a system and method for optimizing telemetry service by modifying the data tolerance values of one or more data types.

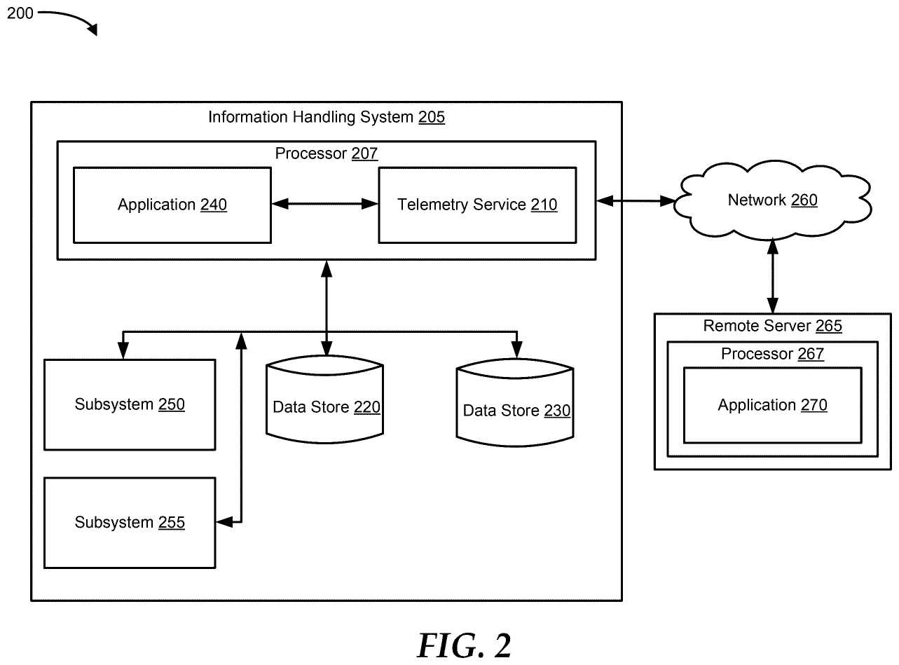

FIG. 2 shows a portion of a telemetry system 200, according to at least one embodiment of the present disclosure. Telemetry system 200 includes an information handling system 205, a network 260, and a remote compute device 265 that includes a processor 267 and an application 270. Information handling system 205, which is similar to information handling system 100 of FIG. 1, includes a processor 207, data stores 220 and 230, and subsystems 250 and 255. Processor 207 includes an application 240 and a telemetry service 210. Telemetry service 210 may be communicatively coupled to application 240, subsystems 250 and 255, and data stores 220 and 230. Telemetry service 210 may also be communicatively coupled to application 270 via network 260. In an example, remote compute device 265 may be any suitable device external to information handling system 205, such as an edge compute device, a dedicated compute server, a remote cloud server, or the like.

The components of telemetry system 200 may be implemented in hardware, software, firmware, or any combination thereof. The components shown are not drawn to scale and telemetry system 200 may include additional or fewer components. For example, information handling system 205 may include an additional subsystem or application. Telemetry service 210 may also be communicatively coupled to more than one remote application via network 260. Processor 207, which is similar to processor 102 or processor 104 of FIG. 1, may perform any suitable operations to execute telemetry service 210 and application 240. The operations described herein as being performed by telemetry service 210 or application 240 may be performed or executed by processor 207. Similarly, processor 267 may perform any suitable operations to execute application 270. In addition, connections between components may be omitted for descriptive clarity.

Telemetry service 210 may be configured to instrument, collect, and/or receive telemetry data from one or more sources like devices, peripherals, and subsystems, such as subsystems 250 and 255. In particular, telemetry service 210 may collect and/or receive telemetry data from one or more sensors of the subsystems. The subsystems may include a processing subsystem, a storage subsystem, a management subsystem, a power subsystem, a cooling subsystem, a thermal subsystem, etc. Each subsystem may be configured to report its health along with other information to one or more applications via telemetry service 210. In one example, subsystem 250 may include a battery management unit.

Telemetry service 210 may also instrument, collect, and/or receive telemetry data for one or more applications, such as applications 240 and 270. These applications may be manufacturer applications, third-party applications, or similar that may be configured to manage, monitor, and/or control an information handling system and/or its subsystems. In this example, application 240 may be locally installed while application 270 may be installed in remote compute device 265. In one example, application 270 may be a cloud service and is communicatively coupled to telemetry service 210 via network 260. In certain embodiments, network 260 may be a public network, such as the Internet, a physical private network, a wireless network, a virtual private network (VPN), or any combination thereof.

In addition, telemetry service 210 may retrieve telemetry data stored in data store 230. Data store 230 may be used to store the cached data may be stored in various formats, such as a file, a table, a list, etc. The cached data may also be stored in an NVRAM or a database. The database may be stored in a drive similar to HDD 154, ODD 156, and SSD 164 of FIG. 1. The telemetry data may also be referred to as cached telemetry data or simply cached data, which has been instrumented collected from one or more sources, such as subsystems 250 and 255. Telemetry service 210 may instrument, collect, and/or receive the telemetry data, also referred to herein simply as data, according to one or more policies, such as a data tolerance policy, a data collection policy, and a data optimization policy. The policies may be stored in a data store, such as data store 230.

Further, telemetry service 210 may be configured to publish and/or generate a default data tolerance policy. The data tolerance policy includes a data tolerance value for each data set, also referred to as data type. The data tolerance value, or simply data tolerance, can be statistically defined by system engineers or administrators. The data tolerance value, also referred to as the data expiration value, can be defined as the minimum time interval or frequency to read the same data set again. For example, fan speed data tolerance is 30 seconds. This means the telemetry services will wait at least 30 seconds before issuing another fan speed data read operation.

Data tolerance values may be dynamically updated or adjusted by telemetry service 210 based on supply and data instrumentation demands. In one embodiment, data instrumentation includes data collection from one or more sources. A set that includes at least one criterion can be employed to update or adjust the data tolerance values, such as performance mode, number of data collection policies in process, user presence detection, etc. One skilled in the art may appreciate that other criteria or a combination of one or more criteria may be utilized without limitation on the scope or applicability of the present disclosure.

Data tolerance values may be adjusted based on the performance mode of an information handling system. An information handling system may have two or more performance modes, such as a maximum performance mode and battery optimized performance mode. By default, the information handling system may switch performance modes when it detects whether it is plugged into or unplugged from an alternating current (AC) outlet. For example, the information handling system may switch to the maximum performance mode when it is plugged into the AC outlet. Accordingly, the information handling system may switch to the battery-optimized performance mode when it is unplugged from the AC outlet. In one embodiment when an information handling system is at the maximum performance mode, then the telemetry service may increase the data tolerance value for certain data sets. For example when information handling system 205 is configured for maximum performance mode, then the data tolerance value of the data sets for subsystem 250 and/or subsystem 255 may be increased. This may be done so that resources used during the data collection may be allocated to another process. Accordingly when information handling system 205 is configured to the battery-optimized performance mode, then the data tolerance value of the data sets for subsystem 250 and/or subsystem 255 may be retained or reduced.

Data tolerance values may be adjusted based on the number of data collection rules or policies in the process. For example, if the number of data collection policies currently active exceeds a threshold, then the telemetry service may increase the data tolerance values of certain data sets that are not being instrumented or collected by the active data collection policies. A data collection policy may be active between its start time and end time. The threshold associated with the number of concurrently running data collection rules or policies may be set automatically by the telemetry service. However, the threshold may also be set manually by a system engineer or an administrator. For example, assuming telemetry service 210 typically collects data sets 1 through 10. However, if applications 240 and 270 are collecting data set 1, data set 2, data set 7, data set 9 and data set 10 at periodic intervals and these data sets are associated with a number of data collection policies currently running that exceeds the threshold, then telemetry service 210 may increase the data tolerance value of data set 3, data set 4, data set 5, data set 6, and data set 8 to a maximum duration to reduce the performance impact on information handling system 205.

The telemetry service may also adjust the data tolerance value of a data set based on whether user presence is detected indicating that a user is near an information handling system. For example, the user presence may be detected based on whether human movement has been detected near the information handling system, a human voice having a location in front of a video display of the information handling system has been detected, an I/O interface associated with the information handling system has been moved, and/or the position of the information handling system has changed, which indicates that the user has picked up or moved the information handling system, such as a laptop or tablet computer. For example, if user presence is detected, then the data tolerance value may be increased. This would allow the subsystem or the information handling system to accommodate requests from the user if any. Accordingly, if user presence is not detected, then the data tolerance value may be retained or decreased. This would allow telemetry service 210 to take advantage of a possible lull in user requests and collect the telemetry data.

Applications and/or microservices can submit a service level agreement (SLA) with a data instrumentation request. The applications and/or microservices may register for notification when the SLA has been validated successfully or passes validation. The data instrumentation request may also include a data collection policy. The telemetry service may validate the SLA and notify the applications and/or microservices of the validation status. The telemetry service may require that the SLA pass validation before initiating the data instrumentation.

Those of ordinary skill in the art will appreciate that the configuration, hardware, and/or software components of telemetry system 200 depicted in FIG. 2 may vary. For example, the illustrative components within telemetry system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

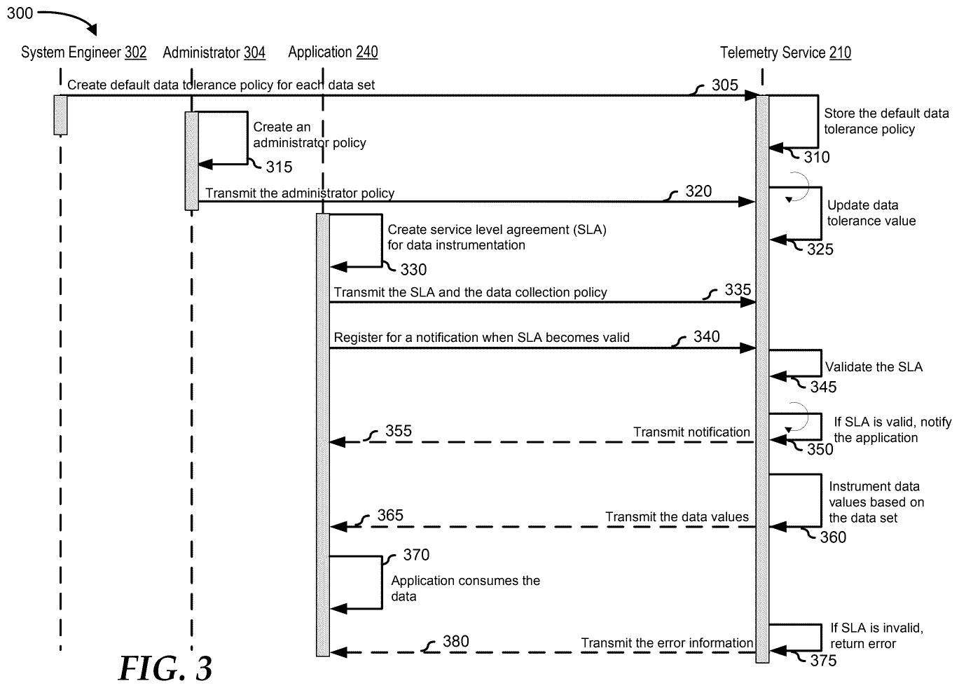

FIG. 3 shows a sequence diagram of a method 300 for optimizing one or more data tolerance values. The sequence diagram shows actions and/or messages between a requester such as system engineer 302, administrator 304, and application 240 of FIG. 2 and a responder such as telemetry service 210 of FIG. 2. While embodiments of the present disclosure are described in terms of the components of telemetry system 200 of FIG. 2, it should be recognized that other components may be utilized to perform the described method. One of skill in the art will appreciate that this sequence diagram explains a typical example, which can be extended to applications or services in practice.

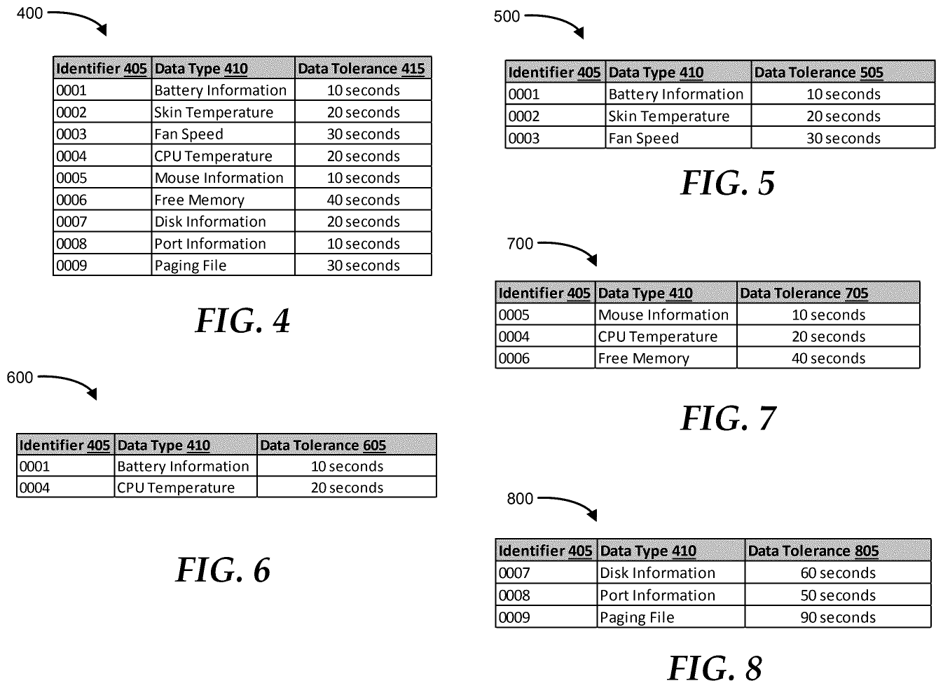

Method 300 typically starts at 305 wherein system engineer 302 may create a default data tolerance policy for each data set in an information handling system and/or telemetry system. The default data tolerance policy may include default data tolerance values for each data set, such as depicted in a table 400 of FIG. 4. The default data tolerance policy for each data set may be transmitted to telemetry service 210 where it stores the default tolerance policy at 310. Telemetry service 210 may store the default data tolerance policy at a data store, such as data store 220 of FIG. 2. At 315, administrator 304 may create an IT policy and/or an administrator policy based on the default data tolerance policy of each data set and transmit the IT policy and/or the administrator policy to telemetry service 210 at 320. At 325, telemetry service 210 may update or modify data tolerance value(s) in the default data tolerance policy based on at least one of several criteria that include: the health of the information handling system, number of active data collection policies, administrator policy, current system load of the information handling system, power status of information handling system, etc.

Telemetry service 210 may modify one or more of the data tolerance values in the default data tolerance policy based on the health status of an information handling system. The health status of the information handling system may be based on one or more factors, such as a percentage threshold associated with its state of health, number of software or event failures being reported, health status report from a BMC, etc. For example, the information handling system may be deemed healthy if its state of health of information handling system is equal to or greater than the percentage threshold. The information handling system may also be deemed healthy if there is no failure event reported. Accordingly, the information handling system may be deemed unhealthy if its status of health is less than the percentage threshold. The information handling system may also be deemed unhealthy if there is at least one failure event reported. If the information handling system is deemed in a healthy state, then the default data tolerance values in the default data tolerance policy may be updated or modified. For example, the default data tolerance values may be increased or decreased. Accordingly, if the information handling system is deemed in an unhealthy state, then the default data tolerance values in the default data tolerance policy may be retained.

The health status of the information handling system may also be based on the health of one or more of its subsystems. For example, the information handling system may be deemed healthy if its subsystems are healthy. Otherwise, the information handling system may be deemed unhealthy. Also, instead of updating all the default data tolerance values in the default data tolerance policy, the update may be performed for each data set. The default data tolerance value of a data set associated with a subsystem may be updated based on the health of the subsystem. If the subsystem is deemed in a healthy state, then the data tolerance value of the data type associated with the subsystem may be updated. For example, the data tolerance value may be increased to have a longer duration. This is because reading the data at a higher frequency when the subsystem is healthy may not provide additional value. If the subsystem is deemed in an unhealthy state, the data tolerance value of the data type associated with the subsystem may be retained. The data tolerance value may be updated to have a shorter duration to allow closer monitoring of the subsystem.

Telemetry service 210 may update the data tolerance values in the default data tolerance policies based on whether the number of active data collection policies exceeds a threshold. For example, the threshold may be set by a systems engineer, an administrator, and/or the telemetry service. The threshold may be updated based on one or more factors, such as the current system load of the information handling system, the health of the information handling system, and the performance mode of the information handling system. For example, the threshold may be increased if the information handling system is healthy. Accordingly, the threshold may be decreased if the information handling system is unhealthy. The data collection policy associated with a data set, or a subsystem may be active when an application transmitted a data read request for that data set or subsystem. For example, if two applications transmit two data read requests, then two data tolerance policies may be active.

Telemetry service 210 may update the data tolerance values in the default data tolerance policies based on an information technology (IT) policy or an administrator policy. For example, the IT policy or the administrator policy may identify a priority for each data set. The priority may be used by the telemetry service to determine which of the data sets may be instrumented first. Telemetry service 210 may also update the data tolerance values in the default data tolerance policies based on the current system load of the information handling system. For example, the data tolerance values may be increased if the current system load is high. This is because frequent periodic collection of subsystem data may increase the system load which can negatively impact system performance. For example, instrumenting platform-level data for the data collection requires CPU cycles and I/O access. By increasing the data tolerance values, the telemetry service may instrument the data sets less frequently. Thus, reducing CPU cycles and I/O access.

Telemetry service 210 may update the data tolerance values in the default data tolerance policies based on the system power status. Telemetry service 210 may also generate a data optimization policy, similar to a table 800 of FIG. 8, with the updated or modified data tolerance values instead of updating the values in the default data tolerance policy. For example, telemetry service 210 may increase the data tolerance value when the information handling system is plugged into the AC power outlet. Accordingly, the telemetry service may retain or decrease the default tolerance value when the information handling system is unplugged.

At 330, application 240 may create an SLA for data instrumentation based on the uses of the application. The SLA may include metrics or guidelines on how fast the data may be instrumented and/or collected. At 335, application 240 may transmit the SLA and the data collection policy to telemetry service 210. Upon receipt of the SLA and the data collection policy, telemetry service 210 may validate the SLA at 345. For example, telemetry service 210 may determine whether the SLA contains metrics as expected. Telemetry service 210 may also authenticate and/or verify the authorization of the sender. At 350, if the SLA is valid, then telemetry service 210 may notify the application. At 355, telemetry service 210 may send a return message to notify application 240 that the SLA is valid.

Telemetry service 210 may then proceed to instrument data set(s) based on the data collection policy at 360. The data collection policy may include rules or parameters associated with the handling of data to be instrumented and/or collected. For example, the data collection policy may include information such as the type of data set to be collected and the data collection duration. In particular, the data collection policy may include a start time and an end time. The data tolerance policy may also include a data tolerance value, also referred to as a collection frequency for each type of data set to be collected. Telemetry service 210 may also perform the data instrumentation according to the data tolerance policy, the data optimization policy, the IT policy, the administrator policy, and/or the criteria at block 360. After instrumenting or collecting data values associated with the data set(s), telemetry service 210 may transmit the data values to application 240 at 365. At 370, application 240 may consume the received data values. At 375, if the SLA is invalid or fails validation, then telemetry service 210 may return an error. Accordingly, telemetry service 210 may not proceed to instrumenting or collecting data values associated with the SLA. At 380, telemetry service 210 may send a return message to notify application 240 of the error.

FIG. 4 shows table 400 of a data tolerance policy, according to at least one embodiment of the present disclosure. The data tolerance policy may be the default data tolerance policy created by system engineer 302 of FIG. 3. Table 400 includes one or more columns, such as an identifier 405, a data type 410, and a data tolerance 415. Identifier 405 may be a unique identifier for each data type. Data type 410 may indicate a particular data type, also referred to as a data set that may be collected by telemetry service 210. The data type may be based on the source of the telemetry data. For example, a battery data type may indicate the type of telemetry data collected from a battery subsystem, such as from a battery management unit. A fan data type may indicate the type of telemetry data collected from a fan subsystem. While there are nine data types included in table 400, one of ordinary skill in the art would recognize that table 400 would include any suitable number of data types without varying from the scope of this disclosure.

Data tolerance 415 may include a data tolerance value for each data type. The data tolerance value may indicate the duration for how long the telemetry data that was read or collected remains to be valid. As such, the data tolerance value may indicate the frequency of collecting that particular data type. Typically, at the expiration of the telemetry data, telemetry service 210 of FIG. 2 may read or collect the telemetry data associated with the data type from its source. Telemetry service 210 may have access to information regarding the source for each data type. For example, telemetry service 210 may collect battery information data type from the battery management unit every 10 seconds.

FIG. 5 shows table 500 of a data collection policy, according to at least one embodiment of the present disclosure. Table 500 includes one or more columns, such as an identifier 405, a data type 410, and a data tolerance 505. The data collection policy, which can be from a first application and/or a first microservice may be associated with table 500 and can include additional parameters, such as a start time and an end time, which provide a duration of the data collection. For example, the start time may be identified as 9:00 AM while the end time may be identified as 10:00 AM. Accordingly, the duration of the data collection is one hour. During that duration, the data set associated with the first application and/or the second microservice may be collected based on a data tolerance or collection frequency. For example, based on data tolerance 505, data associated with the battery information may be collected every 10 seconds while the data associated with skin temperature may be collected every 20 seconds, and data associated with the fan speed may be collected every 30 seconds.

FIG. 6 shows table 600 of a data collection policy, according to at least one embodiment of the present disclosure. Table 600 includes one or more columns, such as an identifier 405, a data type 410, and a data tolerance 605. The data collection policy, which can be from a second application and/or a second microservice may be associated with table 600 and can include additional parameters, such as a start time and an end time, which provide a duration of the data collection. For example, the start time may be identified as 9:15 AM while the end time may be identified as 9:30 AM. Accordingly, the duration of the data collection is 15 minutes. During that duration, the data set associated with the second application and/or the second microservice may be collected based on a data tolerance or collection frequency. For example, based on data tolerance 605, data associated with the battery information may be collected every 10 seconds and the data associated with CPU temperature may be collected every 20 seconds.

FIG. 7 shows table 700 of a data collection policy, according to at least one embodiment of the present disclosure. Table 700 includes one or more columns, such as an identifier 405, a data type 410, and a data tolerance 705. The data collection policy, which can be from a third application and/or a third microservice may be associated with table 700 and can include additional parameters, such as a start time and an end time. The start time and the end time can provide the duration of the data collection. For example, the start time may be identified as 9:20 AM while the end time may be identified as 10:30 AM. Accordingly, the duration of the data collection is 1 hour and 10 minutes. During that duration, the data set associated with the third application and/or the third microservice may be collected based on a data tolerance or collection frequency. For example, during that duration, the data sets associated with table 700 may be collected based on data tolerance 705. In particular, data values of the mouse information data type may be collected every 10 seconds while data values of the CPU temperature data type may be collected every 20 seconds, and data values of the free memory data type may be collected every 40 seconds. Although the data tolerance values of the data collection policies above are similar to the data tolerance values of the data tolerance policy in table 400 of FIG. 4, the data tolerance values in the data collection policies of tables 500, 600, and 700 may be modified data tolerance values based on the administrative policy, IT policy, and other criteria.

FIG. 8 shows table 800 of a data optimization policy, according to at least one embodiment of the present disclosure. Table 800 includes one or more columns, such as an identifier 405, a data type 410, and a data tolerance 805. The data optimization policy can be associated with table 800 and can include additional parameters, such as a start time and an end time, which provide a duration of the data optimization. The start time may be based on the duration of an overlap between the data collection policies currently active. For example, the duration of the overlap may be based on the duration of the aforementioned first data collection policy, second data collection policy, and third data collection policy. In particular, the start time may be identified as 9:20 AM while the end time may be identified as 9:30 AM.

During the duration of the overlap, the data tolerance value of the data set exclusive of the data collection policies that are active during the overlap may be increased. This is to optimize the performance of the information handling system by attempting to reduce the frequency of the data sets to be instrumented during the overlap. For example, during that duration, the data sets associated with table 800 may be collected less frequently based on the increased data tolerance value as shown in data tolerance 705. In one example, the data tolerance value of a disk information data type may be increased from 20 seconds to 60 seconds while the data tolerance value of the port information data type may be increased from 10 seconds to 50 seconds, and the data tolerance value of the paging file data type may be increased from 30 seconds to 90 seconds. Thus, the telemetry service may collect these data sets based on the modified data tolerance values instead of its original data tolerance values. Accordingly, the telemetry service can characterize the best start data sampling or data collection for these data types. Thus, changing the peak power consumption for improved power distribution. When the overlap duration is passed, the data tolerance values of the data sets in the data optimization table may be reverted to their original data tolerance values.

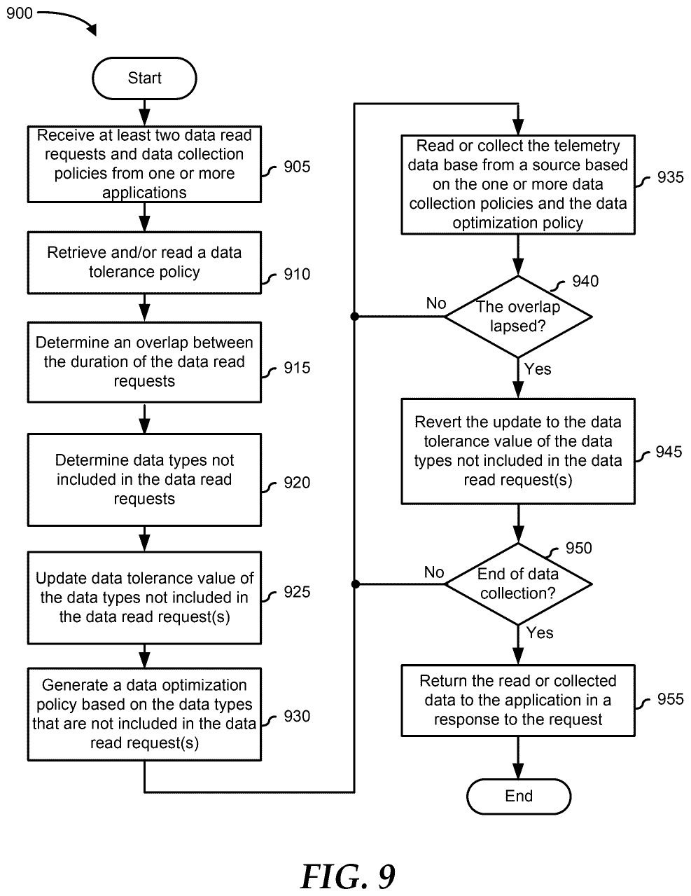

FIG. 9 shows a flowchart of a method for optimizing one or more data tolerance values. Method 900 may be performed by any suitable component of telemetry system 200 of FIG. 2 including, but not limited to, telemetry service 210 and applications 240 and 270. While embodiments of the present disclosure are described in terms of the components of telemetry system 200, it should be recognized that other components may be utilized to perform the described method.

Method 900 typically starts at block 905 where a telemetry service, such as telemetry service 210 may receive at least two data read requests or data instrumentation requests from one or more applications. For example, one application may send multiple data read requests. In another example, each application may send one data read request. For example, telemetry service 210 may receive a data request from applications 240 and 270. Each of the data read requests may include an SLA and a data collection policy with additional information, such as the type of data to be instrumented, a start time, and an end time of the data instrumentation. The data collection policy and associated information may be stored by the telemetry service in one of several formats, such as a lookup table as depicted in tables 500, 600, and 700. In addition, the SLA may also be stored for reference subsequent to its validation. In another example, the application may have transmitted the SLA to the telemetry service prior to the data read request or the data instrumentation request for validation by the telemetry service. The method proceeds to block 910.

At block 910, telemetry service 210 may retrieve and/or read a data tolerance policy, such as the data tolerance policy associated with table 400 of FIG. 4. The data tolerance policy may be used to determine information such as data tolerance value for each data type. The data expiration policy may be retrieved from a database or a data store, such as data store 220. The method proceeds to block 915 where the telemetry service may determine an overlap between the duration of one or more data collection policies associated with the data read requests received. In one example, telemetry service 210 may receive three data collection policies associated with three data read requests or three data collection requests, also referred to as data instrumentation requests, from three different applications.

In particular, telemetry service 210 may have received data collection policies associated with tables 500, 600, and 700 of FIG. 5, FIG. 6, and FIG. 7, respectively. In this example, the first data collection policy which is associated with table 500 may be configured to run from 9:00 AM to 10:00 AM. The second data collection policy which is associated with table 600 may be configured to run from 9:15 AM to 9:30 AM. The third data collection policy which is associated with table 700 may be configured to run from 9:20 AM to 10:30 AM. As such, the aforementioned data collection policies have an overlap or are all running from 9:20 AM to 9:30 AM. The method proceeds to block 920.

At block 920, where telemetry service 210 may determine the data types that are not included in the data collection process during the overlap based on the data tolerance policy. For example, telemetry service 210 determines the data types not collected during the overlap based on the data tolerance policy associated with table 400 of FIG. 4. In this example, the data types not collected during the overlap include disk information, port information, and paging file. The method proceeds to block 925, where the telemetry service may update or modify the data tolerance values of the data types that are not included in the overlap to new data tolerance values. For example, telemetry service 210 may increase the data tolerance values of one or more data types that are not included in the data instrumentation requests during the overlap duration. The increase may be increased by a factor of the default data tolerance value. In one example, telemetry service 210 may increase the data tolerance value of the disk information data type from 20 seconds to 60 seconds from 9:20 AM to 9:30 AM. In addition, telemetry service 210 may increase the data tolerance value of the port information data type from 10 seconds to 50 seconds from 9:20 AM to 9:30 AM. Further, telemetry service 210 may increase the data tolerance value of the paging file data type from 30 seconds to 90 seconds from 9:20 AM to 9:30 AM. This allows optimization of the data instrumentation as the frequency of collecting the data values of these is increased. The method proceeds to block 930.

At block 930, telemetry service 210 may generate a data optimization policy based on the data types and increase the data tolerance values determined at blocks 920 and 925. The data optimization policy may include information associated with the data types, such as their identifiers and the updated collection frequencies. The data optimization policy may also include the duration of the optimized data collection, such as a start time and an end time. In one example, the data optimization policy may be similar to the data optimization policy associated with table 800 of FIG. 8. The data optimization policy may also have a start time of 9:20 AM and an end time of 9:30 AM. The data optimization policy may also be customizable using a rule and/or policy. For example, the updated or modified data tolerance value may not be applicable based on one or more criteria such as usage context, priority, or preferred tolerance value.

The method proceeds to block 935 where telemetry service 210 may read or collect the telemetry data from one or more sources, such as the subsystem, device, or peripheral based on the received data read request or data instrumentation request from one or more applications. The data instrumentation or collection may be based on a data collection policy, data optimization policy, and/or data tolerance policy. The method proceeds to decision block 940, where telemetry service 210 may determine whether the duration of the overlap is passed. If the overlap duration is passed, then the “YES” branch is taken, and the method proceeds to block 945. If the overlap duration is not passed, then the “NO” branch is taken, and the method proceeds to block 935. At block 945, telemetry service 210 may revert the updated or modified value of the data types not included in the data read requests to their original or default values prior to the update. The method proceeds to decision block 950.

At decision block 950, telemetry service 210 may determine whether the end of the data collection duration is reached. This may be performed for each of the data read or data instrumentation requests received. If the end of the data collection duration is reached, then the “YES” branch is taken, and the method proceeds to block 955. If the end of the data collection duration is not reached, then the “NO” branch is taken, and the method proceeds to block 935. At block 955, telemetry service 210 may transmit a response to one or more applications that transmitted the data read or data instrumentation requests, wherein the response includes the telemetry data values requested. Afterwards, the method ends.

Although FIG. 3 and FIG. 9 show example blocks of method 300 and method 900 in some implementations, method 300 and method 900 may include additional blocks, fewer blocks, different blocks, or differently arranged blocks than those depicted in FIG. 3 and FIG. 9. Those skilled in the art will understand that the principles presented herein may be implemented in any suitably arranged processing system. Additionally, or alternatively, two or more of the blocks of method 300 and method 900 may be performed in parallel. For example, blocks 910 and 915 of method 900 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
generating, by a processor, a data tolerance policy with a data tolerance value for a data type;
if a data instrumentation request meets a set of criteria that includes whether a number of active data collection policies exceeds a threshold, then modifying the data tolerance value of the data type in the data tolerance policy;
collecting data according to a modified data tolerance value, the data instrumentation request, and the data tolerance policy; and
transmitting the data in a response to the data instrumentation request.

2. The method of claim 1, further comprising validating a service level agreement associated with the data instrumentation request.

3. The method of claim 2, wherein the collecting of the data is performed subsequent to the validating of the service level agreement.

4. The method of claim 2, further comprising notifying an application that transmitted the data instrumentation request when the service level agreement passes validation.

5. The method of claim 2, further comprising returning an error message when the service level agreement fails validation.

6. The method of claim 1, wherein the set of criteria includes system power status of an information handling system.

7. The method of claim 1, wherein the set of criteria includes current system load of an information handling system.

8. The method of claim 1, wherein the set of criteria includes whether a user is detected.

9. An information handling system, comprising:
a memory to store a data expiration policy; and
a processor to communicate with the memory, the processor to:
generate a data tolerance policy with a data tolerance value for a data type;
if a data collection request meets a set of criteria that includes whether a number of active data collection policies exceeds a threshold, then modify the data tolerance value of the data type in the data tolerance policy;
instrument data according to a modified data tolerance value, the data collection request, and the data tolerance policy; and
transmit the data in a response to the data collection request.

10. The information handling system of claim 9, wherein the processor is further configured to validate a service level agreement associated with the data collection request.

11. The information handling system of claim 10, wherein the processor is further configured to to instrument the data subsequent to a successful validation of the service level agreement.

12. The information handling system of claim 10, wherein the processor is further configured to notify an application that transmitted the data collection request when the service level agreement is successfully validated.

13. The information handling system of claim 10, wherein the processor is further configured to return an error message when the service level agreement fails validation.

14. A non-transitory computer-readable medium to store instructions that are executable to perform operations comprising:
receiving a first request to collect a first data type for a first duration and a second request to collect a second data type for a second duration;
if there is a duration that overlaps between the first duration and the second duration, then modifying a data tolerance value of a third data type;
generating a policy that includes a modified data tolerance value of the third data type during the duration that overlaps instead of the data tolerance value;
instrumenting a first data value of the first data type, a second data value of the second data type, and a third data value of the third data type according to the policy; and
transmitting a first response that includes the first data value and a second response that includes the second data value.

15. The non-transitory computer-readable medium of claim 14, wherein the first request is from a first application and the second request is from a second application.

16. The non-transitory computer-readable medium of claim 14, wherein the operations further comprise subsequent to the duration that overlaps between the first duration and the second duration, reverting the modified data tolerance value of the third data type to the data tolerance value.

17. The non-transitory computer-readable medium of claim 14, wherein the operations further comprise validating a service level agreement associated with the first request.

18. The non-transitory computer-readable medium of claim 17, wherein the instrumenting of the first data value is performed subsequent to a successful validation of the service level agreement.

19. The non-transitory computer-readable medium of claim 17, wherein the operations further comprise returning an error to an application that transmitted the first request when the service level agreement fails validation.

20. The non-transitory computer-readable medium of claim 14, wherein the data tolerance value of the third data type is in a data tolerance policy.
